(19) United States
(12) Patent Application Publication
(10) Pub. No.: US 2013/0015822 A1
(43) Pub. Date: Jan. 17, 2013

(54) Multi-Purpose Power Management Apparatus, Power Path Control Circuit and Control Method Therefor

(71) Applicant: Nien-Hui Kung, Hsinchu City (TW)

(72) Inventor: Nien-Hui Kung, Hsinchu City (TW)

(73) Assignee: Richtek Technology Corporation, R.O.C.

(21) Appl. No.: 13/181,203

(22) Filed: Jul. 12, 2011

(51) Int. Cl. H02J 7/04; H02J 7/06

(52) U.S. Cl. 320/145; 320/163; 320/162

(57) ABSTRACT

The present invention discloses a multi-purpose power management apparatus, a power path control circuit, and a control method therefor. The multi-purpose power management apparatus controls power conversion between an input power and an output power and charging operation from the output power to a battery. The multi-purpose power management apparatus includes: a switch circuit including at least one power transistor; a switch control circuit generating a PWM signal to control the power transistor, for controlling the power conversion between the input power and the output power; a charging management circuit for controlling the charging operation from the output power to the battery; and a path selection circuit for determining whether the charging operation is controlled by the charging management circuit.

### BACKGROUND OF THE INVENTION

1. Field of Invention

The present invention relates to a multi-purpose power management apparatus, a power path control circuit and a control method therefor, in particular to such multi-purpose power management apparatus, power path control circuit and control method that automatically determine whether a charging management circuit needs to be enabled according to the connection relationship between a system load and a battery, such that the apparatus, circuit and method can be applied to different applications regardless whether the system load is directly or indirectly connected to the battery.

2. Description of Related Art

FIG. 1 shows a schematic diagram of a prior art power supply system. As shown in FIG. 1, the power supply system 10 includes a switching regulator 1a which converts external power from an input side Vin to power of an output side Vout. The output side Vout supplies power to the system load (which is for example a computer host) and charges a battery Batt. When the input side is disconnected from the external power, the battery Batt would output power to the output side Vout. A feedback circuit 13 includes two resistors R1 and R2 connected to each other in series. One terminal of the resistor R1 is coupled to the output voltage Vout, and one terminal of the resistor R2 is coupled to the ground. The feedback signal FB1 is extracted from the voltage difference across the resistor R2. An error amplifier 11 receives the feedback signal FB1, and compares it with a reference voltage Vref1 to generate an error signal Comp1 as the input of a pulse width modulation (PWM) signal generator 12. According to the error signal Comp1, the PWM signal generator 12 generates a switch signal to control an upper transistor Q1 and a lower transistor Q2. The upper transistor Q1 and the lower transistor Q2 form a switch circuit 14. By the operations of the transistors Q1 and Q2, a current is generated through an inductor L. The output side Vout supplies a portion of the current to the battery. In order to control the charging current of the battery Batt, a sensing resistor RS is disposed between the output side Vout and the battery Batt. An error amplifier 16 detects the voltage difference between two ends of the sensing resistor RS and sends it as an input to the PWM signal generator 12, and thereby the charging current to the battery is controlled within a predetermined range. In such prior art the error amplifier 11, the PWM signal generator 12, the switch circuit 14, and the error amplifier 16 are usually integrated into a chip or an apparatus. However, the chip or the apparatus is only suitable for the configuration that the battery Batt is directly connected to the output side Vout through the sensing resistor RS, as shown in FIG. 1. It is not suitable for a power supply system of another configuration, such as the one shown in FIG. 2 below.

Referring to FIG. 2, the power supply system 20 comprises a switching regulator 1a, a charging management circuit 2a, a battery Batt, and a PMOS transistor 27. The switching regulator 1a converts external power from an input side Vin to power of an output side Vout. The output side Vout supplies power to the system load (which is for example a computer host) and charges the battery Batt. When the input side is disconnected from the external power, the battery Batt would output power to the output side Vout. The power supply system 20 detects whether the battery Batt needs to be charged or it has been fully charged, and controls the PMOS transistor 27 thereby to provide or stop charging current to the battery Batt.

The feedback circuit 26 includes two resistors R3 and R4 connected to each other in series. One terminal of the resistor R3 is coupled to the voltage Vbatt outputted by the battery Batt, and one terminal of the resistor R4 is coupled to the ground. An error amplifier 21 receives the feedback signal FB2, and compares it with a reference voltage Vref2 to generate an error signal Comp2. An error amplifier 24 detects the voltage difference across the sensing resistor RS and outputs an error signal Comp4. An error amplifier 23 compares the error signal Comp4 with a reference voltage Vref3 to output an error signal Comp3. An adder 25 sums up the two error signals Comp2 and Comp3, and outputs the sum signal to the charging controller 22. According to the sum signal, the charging controller 22 determines whether the battery Batt needs to be charged or it has been fully charged, and controls the PMOS transistor 27 thereby.

In such prior art the error amplifier 11, the PWM signal generator 12, the switch circuit 14, the error amplifiers (21, 23, 24), the charging controller 22, and the adder 25 are usually integrated into a chip or a power management apparatus 2d. However, the power management apparatus is only suitable for the configuration that the battery Batt is connected to the output side Vout through the sensing resistor RS and the PMOS transistor 27, as shown in FIG. 2. It can not be applied to a power supply system of another configuration, such as the one without the power transistor 27 as shown in FIG. 1.

In view of above, the present invention overcomes the foregoing drawbacks by providing a multi-purpose power management apparatus, a power path control circuit and a control method therefor. Such multi-purpose power management apparatus, power path control circuit and control method can automatically determine whether a charging management circuit needs to be enabled according to the connection relationship between a system load and a battery, such that the apparatus, circuit and method can be applied to different applications regardless whether the system load is directly or indirectly connected to the battery through a switch.

### SUMMARY OF THE INVENTION

An objective of the present invention is to provide a multi-purpose power management apparatus.

Another objective of the present invention is to provide a charging path control circuit.

Another objective of the present invention is to provide a method for controlling power paths.

To achieve the foregoing objectives, in one aspect, the present invention provides a multi-purpose management apparatus controlling power conversion from input power to output power and controlling charging operation to a battery from the output power, the multi-purpose management apparatus comprising: a switch circuit including at least one first power transistor; a switch control circuit generating a switch signal operating the power transistor to control the power conversion from the input power to the output power; a charging management circuit for controlling the charging operation from the output power to the battery; and a path selection circuit determining whether the charging operation to the battery is controlled by the charging management circuit.

In the foregoing multi-purpose management apparatus, when the output power is coupled to the battery through a second power transistor, the path selection circuit designates the charging management circuit to operate the second power transistor for controlling the charging operation to the battery; when the output power is not coupled to the battery through the second power transistor, the path selection circuit does not designate the charging management circuit to control the charging operation to the battery.

In one embodiment, the path selection circuit includes a multiplexer which determines whether the charging operation is controlled by the charging management circuit according to an external setting signal.

In another embodiment, the charging management circuit generates an output signal outputted through a pin, and the path selection circuit includes: a detection signal generator generating a detection signal outputted through the pin to generate a detection voltage; a comparator comparing the detection voltage with a reference voltage; and a multiplexer determining whether the charging operation to the battery is controlled by the charging management circuit according to an output from the comparator.

In one embodiment, the charging management circuit includes a first error amplifier generating a first error signal according to information related to a battery charging current, and the path selection circuit determines to transmit the first error signal to the switch control circuit or the charging management circuit.

In yet another aspect, the present invention provides a charging path control circuit for selecting at least one control loop according to a connection relationship between an output power and a battery, the charging path control comprising: a charging management circuit for controlling a charging operation to the battery from the output power; and a path selection circuit determining whether the charging operation to the battery is controlled by the charging management circuit according to whether or not a power transistor is coupled between the output power and the battery.

In yet another aspect, the present invention provides a power path control method, comprising: converting an input power to an output power; performing a charging operation to a battery from the output power through a charging path; detecting whether a power transistor is disposed on the charging path; controlling the charging operation to the battery by controlling the power transistor when the power transistor is disposed on the charging path; and controlling the charging operation to the battery by controlling the conversion between the input power and the output power when the power transistor is not disposed on the charging path.

Preferably, the power path control method further comprises: detecting a current on the charging path to generate information related to a battery charging current; feeding back the information to control the power transistor when the power transistor is disposed on the charging path; and feeding back the information to control the conversion between the input power and the output power when the power transistor is not disposed on the charging path.

In the foregoing power path control method, the step of detecting whether the power transistor is disposed on the charging path preferably comprises: providing a pin for connecting to a gate terminal of the power transistor or to ground; generating a detection signal outputted through the pin to generate a detection voltage; and comparing the detection voltage with a reference to determine whether the power transistor exists.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram of a prior art power supply system.

FIG. 2 shows a schematic diagram of another prior art power supply system.

FIG. 3 shows a schematic diagram of an embodiment of the present invention, illustrating a multi-purpose management apparatus applied to a power supply system.

FIG. 4 shows a schematic diagram of the multi-purpose management apparatus in FIG. 3 applied to another power supply system.

FIG. 5 shows another embodiment of the path selection circuit 3c.

FIGS. 6A-6B show two embodiments illustrating examples of the detection signal generator 33.

FIGS. 7A-7B show two other embodiments illustrating examples of the detection signal generator 33.

FIG. 8 shows a schematic diagram of another embodiment of the present invention, illustrating a multi-purpose management apparatus applied to a power supply system.

FIG. 9 shows a schematic diagram of the multi-purpose management apparatus in FIG. 8 applied to another power supply system.

### DESCRIPTION OF THE PREFERRED EMBODIMENTS

The drawings as referred to throughout the description of the present invention are for illustration only, to show the functions of the devices and the signal interrelationships between the devices, but not drawn according to actual dimensions or scales.

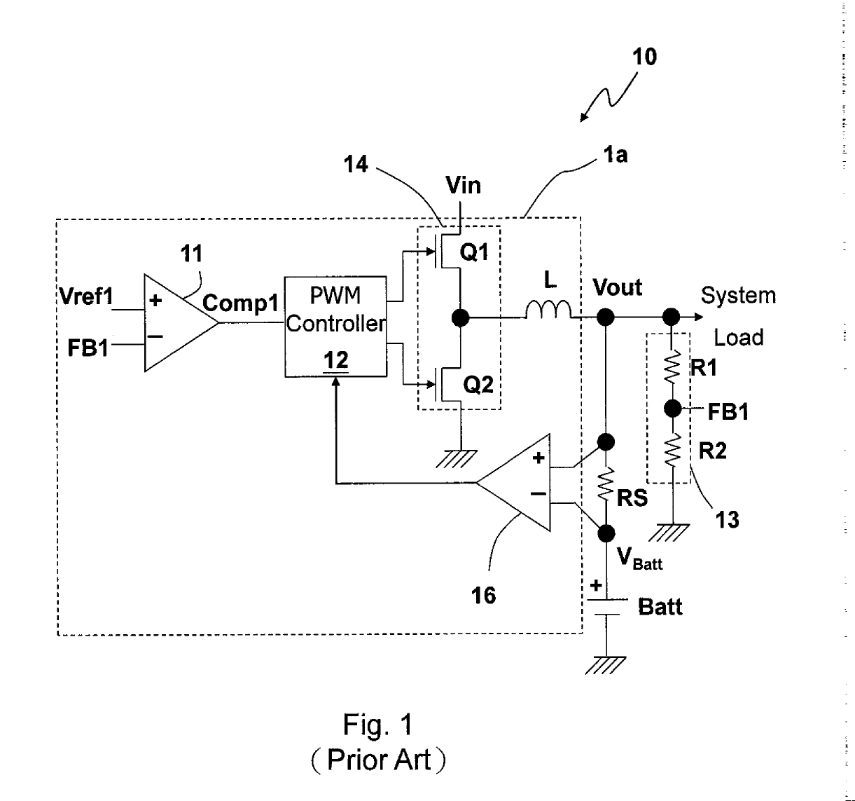

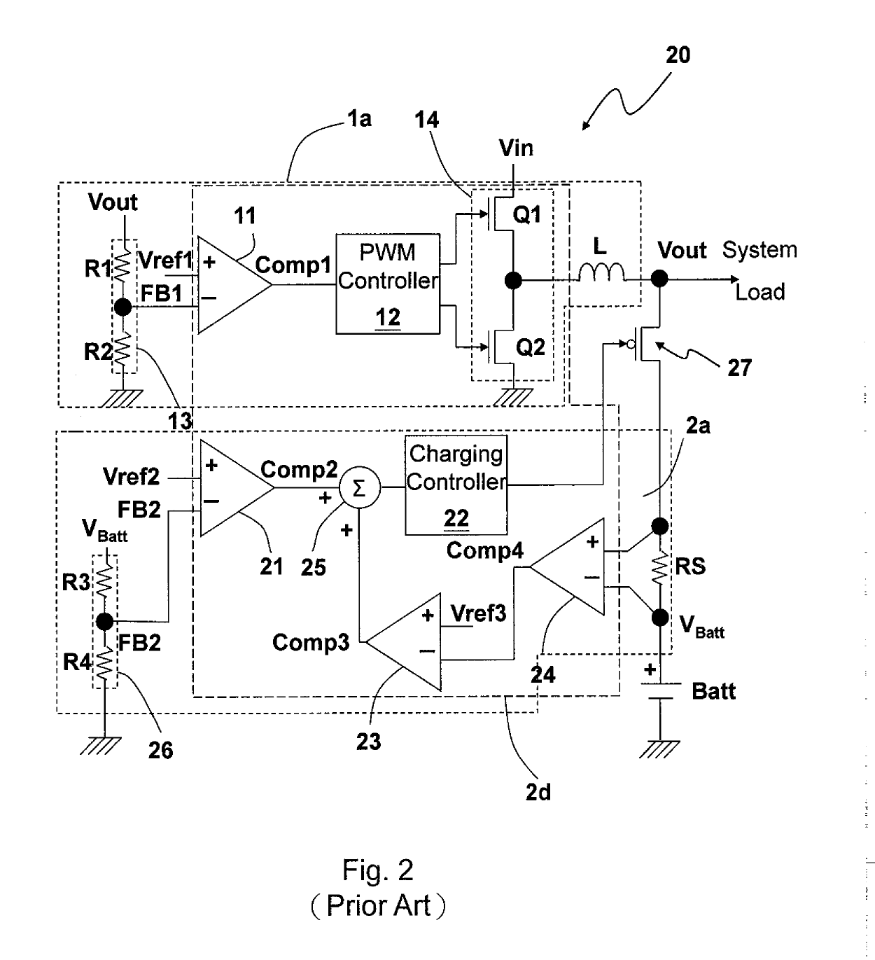

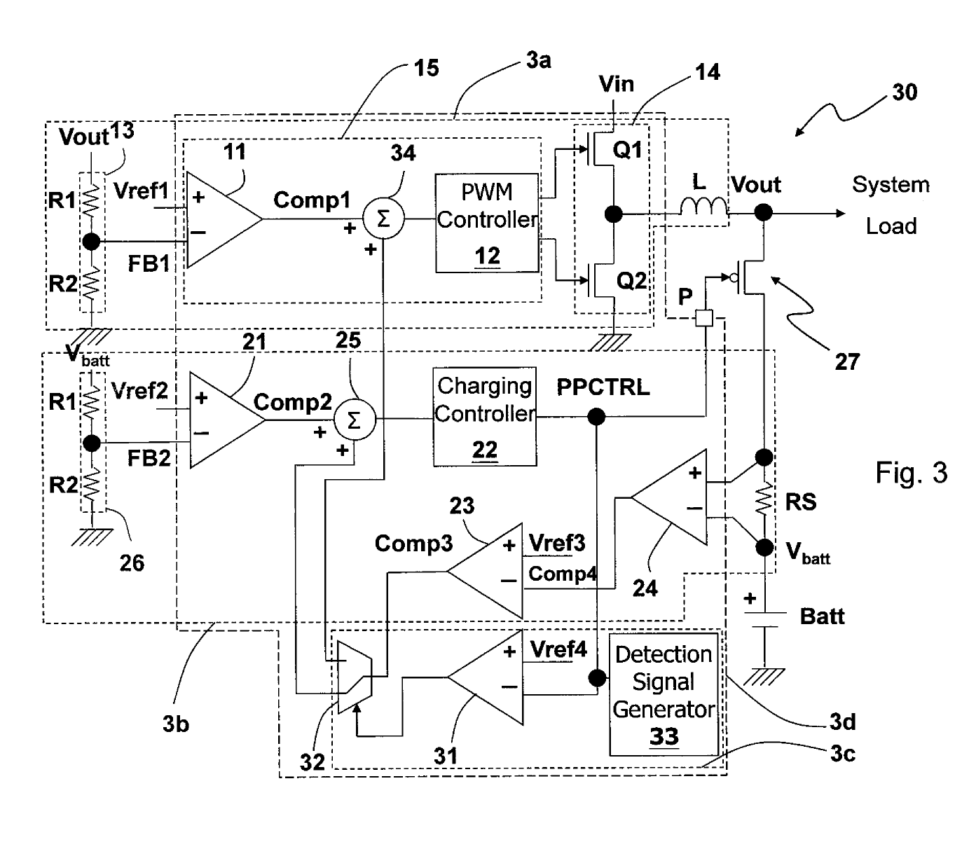

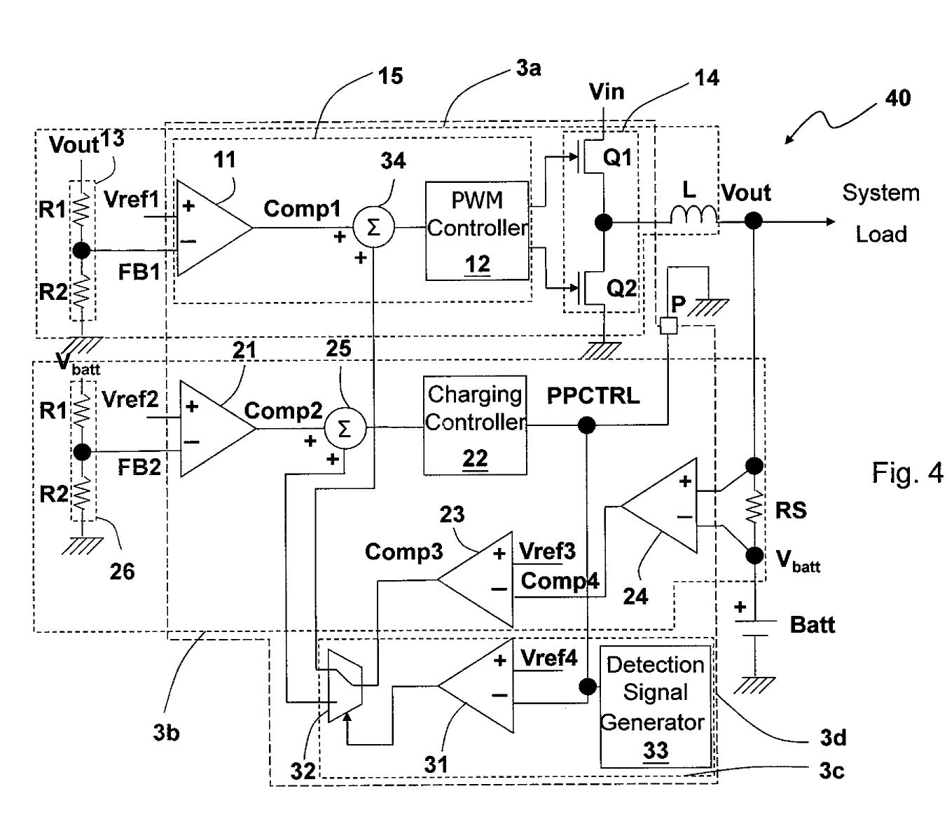

Referring to FIGS. 3 and 4, these figures show that the multi-purpose management apparatus 3d of the present invention can be applied to different applications to match with different printed circuit boards in use. It is suitable for the configuration that the battery Batt is connected to the output side Vout through the sensing resistor RS, as shown in FIG. 1, and is also suitable for the configuration that the battery Batt is connected to the output side Vout through the sensing resistor RS and the PMOS transistor 27, as shown in FIG. 2. Examples of such applications are respectively shown in FIGS. 3 and 4. The multi-purpose management apparatus 3d can detect which configuration it is applied to by various aways. In one embodiment, this can be manually set by an external signal. In another embodiment, the multi-purpose management apparatus 3d has a pin which is designed for connecting to the transistor 27 in one configuration, and the potential of this pin can be used to automatically detect which configuration the multi-purpose management apparatus 3d is connected to.

Referring to FIG. 3, the power supply system 30 comprises a switching regulator 3a, a charging management circuit 3b, a battery Batt, a transistor 27 (shown to be a PMOS transistor as an example; it can be an NMOS transistor instead), and a path selection circuit 3c. The switching regulator 3a controls the power conversion from an input side Vin to an output side Vout. The charging management circuit 3b controls the charging operation of the battery Batt. The path selection circuit 3c designates the information of the charging current of the battery Batt to be fed back to the switching regulator 3a or the charging management circuit 3b according to whether the transistor 27 is disposed between the output side Vout and the battery Batt.

More specifically, the switching regulator 3a converts the external power from an input side Vin to an output side Vout. The output side Vout supplies power to the system load and charges the battery Batt. When the input side is disconnected from the external power, the battery Batt would output power to the output side Vout. The power supply system 30 detects whether the battery Batt needs to be charged or it has been fully charged, and controls the PMOS transistor thereby to provide or stop the charging current to the battery Batt.

A feedback circuit 13 includes two resistors R1 and R2 connected to each other in series. One terminal of the resistor R1 is coupled to the output voltage Vout, and one terminal of the resistor R2 is coupled to the ground. The feedback signal FB1 is the voltage difference between two ends of the resistor R2. In the switching regulator 3a, an error amplifier 11 receives the feedback signal FB1, and compares it with a reference voltage Vref1 to generate an error signal Comp1 as an input to a PWM signal generator 12. According to the error signal Comp1, the PWM signal generator 12 generates a switch signal to control an upper transistor Q1 and a lower transistor Q2. The upper transistor Q1 and the lower transistor Q2 form a switch circuit 14. By the operations of the transistors Q1 and Q2, a current is generated through an inductor L. The output side Vout supplies a portion of the current to charge the battery. As shown in FIG. 3, because the PMOS transistor 27 is disposed between the output side Vout and the battery Batt, the multiplexer 32 of the path selection circuit 3c selects the output path to an adder 25 rather than the output path to an adder 34 (the details of the path selection circuit 3c will be explained below), so the adder 34 of the switching regulator 3a receives the error signal Comp1 only. The error amplifier 11, the adder 34, and the PWM signal controller 12 form a switch control circuit 15.

A feedback circuit 26 includes two resistors R3 and R4 connected to each other in series. One terminal of the resistor R3 is coupled to the output voltage Vbatt of the battery Batt, and one terminal of the resistor R4 is coupled to the ground. In the charging management circuit 3b, an error amplifier 21 receives the feedback signal FB2, and compares it with a reference voltage Vref2 to generate an error signal Comp2. An error amplifier 24 detects the voltage difference across the sensing resistor RS and outputs an error signal Comp4. An error amplifier 23 compares the error signal Comp4 with a reference voltage Vref3 to output an error signal Comp3. Because the multiplexer 32 of the path selection circuit 3c selects the output path to the adder 25, the two error signals Comp2 and Comp3 is summed up by the adder 25, and the sum signal is outputted to the charging controller 22. The sum signal represents the information of the battery voltage and the charging current of the battery Batt. According to the sum signal, the charging controller 22 determines whether the battery Batt needs to be charged or it has been fully charged, and outputs a signal PPCTRL to control the PMOS transistor 27 thereby.

In this embodiment, the path selection circuit 3c includes a comparator 31, a multiplexer 32 and a detection signal generator 33. The detection signal generator 33 generates a detection signal transmitted through the output node PPCTRL of the charging controller 22 and the pin P, to detect the status of the external connection with the pin P. As shown in FIG. 3, because the pin P is connected to the PMOS transistor 27, the detection signal generated from the detection signal generator 33 causes the node PPCTRL to have a relatively higher voltage. The negative input terminal of the comparator 31 receives the voltage resulted from the detection signal, and the comparator 31 compares it with a reference voltage Vref4 to output a control signal to the multiplexer 32 such that a transmission path is selected for the error signal Comp3. The path selection circuit 3c sets the path selection preferably only when the system just starts or reboots, so that the output signal PPCTRL of the charging controller 22 does not affect the path selection circuit 3c when the system 30 is in a normal operation status. In one embodiment, when the power supply system 30 is turned on, a POR (Power-On-Reset) signal is generated and it can be used as an enable signal to control the comparator 31 and/or the detection signal generator 33. After the system 30 is completely turned on, the comparator 31 and/or the detection signal generator 33 is disable, so the selection made by the multiplexer 32 is fixed, and will not be interfered by the variation of the signal PPCTRL.

Compared with FIG. 3, the system load of the power supply system 40 in FIG. 4 is connected to the battery Batt through only the sensing resistor RS without the PMOS transistor 27 in between, and hence, the pin P for outputting the signal PPCRRL from the charging controller 22 is grounded. The negative input terminal of the comparator 31 is also coupled to the ground. The comparator 31 compares its negative input with the reference voltage Vref4, and outputs a control signal to the multiplexer 32 so that the multiplexer 32 selects to send the error signal Comp3 to the adder 34. The adder 34 sums up the error signals comp1 and comp3, and outputs the sum to the PWM controller 12. In one embodiment, the switch control circuit 15, the switch circuit 14, the error amplifiers (11, 21, 23, 24), the charging controller 22, the adders (25, 34), and the path selection circuit 3c can be integrated into a chip or a multi-purpose power management apparatus 3d. Moreover, the chip or the apparatus is suitable for the application wherein the battery Batt is connected to the output side Vout through the PMOS transistor 27 and the sensing resistor RS, as shown in FIG. 3, and is also suitable for the application that the battery Batt is connected to the output side Vout through the sensing resistor RS only, as shown in FIG. 4. However, the circuits and the devices included in the multi-purpose power management apparatus are not limited by the above embodiment. For example, if the operation power of the transistors in the switch circuit 14 is too high, they can be moved to outside of the multi-purpose power management apparatus 3d and are not integrated therein.

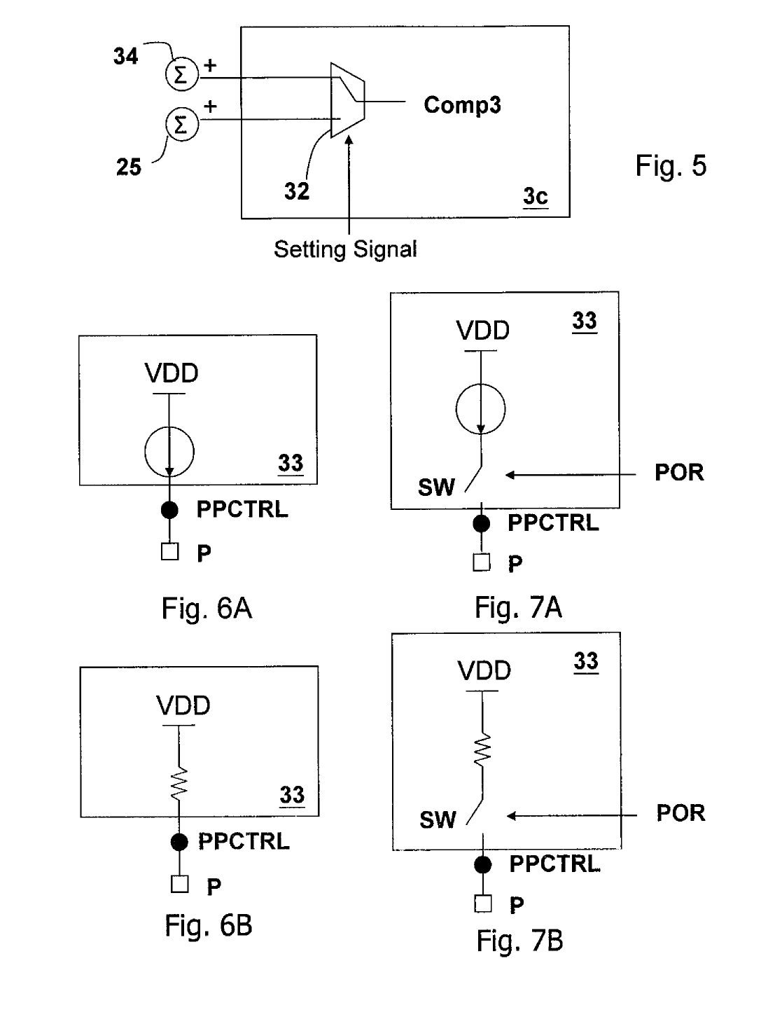

The foregoing embodiment is an example to illustrate that the path selection circuit 3c can automatically detect whether the transistor 27 is disposed in the charging path to the battery Batt, and determine to feed back the charging current information of the battery Batt to the switching regulator 3a or the charging management circuit 3b accordingly. However, this is not the only way to make the path selection. As shown in FIG. 5, another way is to provide a setting signal from the external of the chip or the apparatus, to set the feedback path of the charging current information of the battery Batt. In this embodiment, the path selection circuit 3c can only include the multiplexer 32.

FIGS. 6A-6B show two embodiments illustrating examples of the detection signal generator 33. For example, the detection signal generator 33 can be a weak current source or a resistor. Its upper terminal is connected to a suitable voltage (such as a chip operation voltage VDD, but is not limited to this), and its lower terminal is coupled to the output node PPCTRL (pin P) of the charging controller 22. When the system starts or reboots, if the pin P is coupled to the PMOS transistor 27, the detection signal generator 33 can raise the voltage of the node PPCTRL. On the other hand, if the pin P is grounded, the detection signal generator 33 cannot raise the voltage of the node PPCTRL. When the system is in a normal operation status, the voltage of the node PPCTRL is dominated by the output of the charging controller 22, and is not affected by the detection signal generator 33.

FIGS. 7A-7B show two other embodiments illustrating examples of the detection signal generator 33. In the two embodiments, the detection signal generator 33 further includes a switch SW which is turned on by the power-on reset signal POR. When the system enters the normal operation status after booting, the switch SW is turned OFF to reduce power consumption.

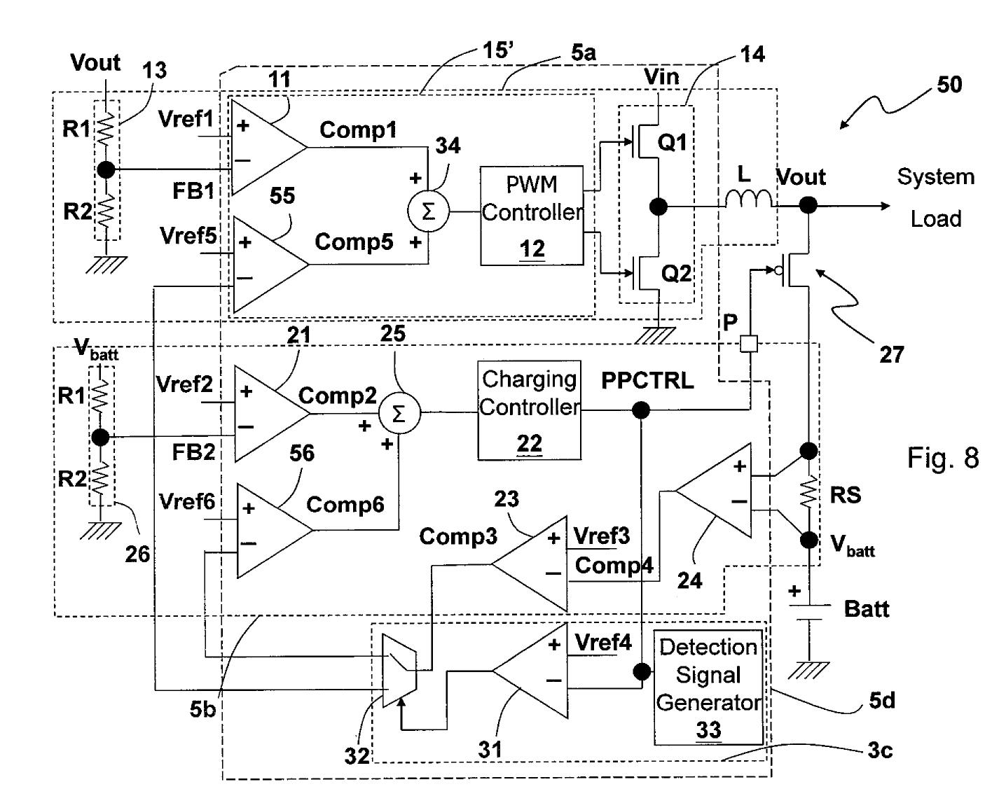

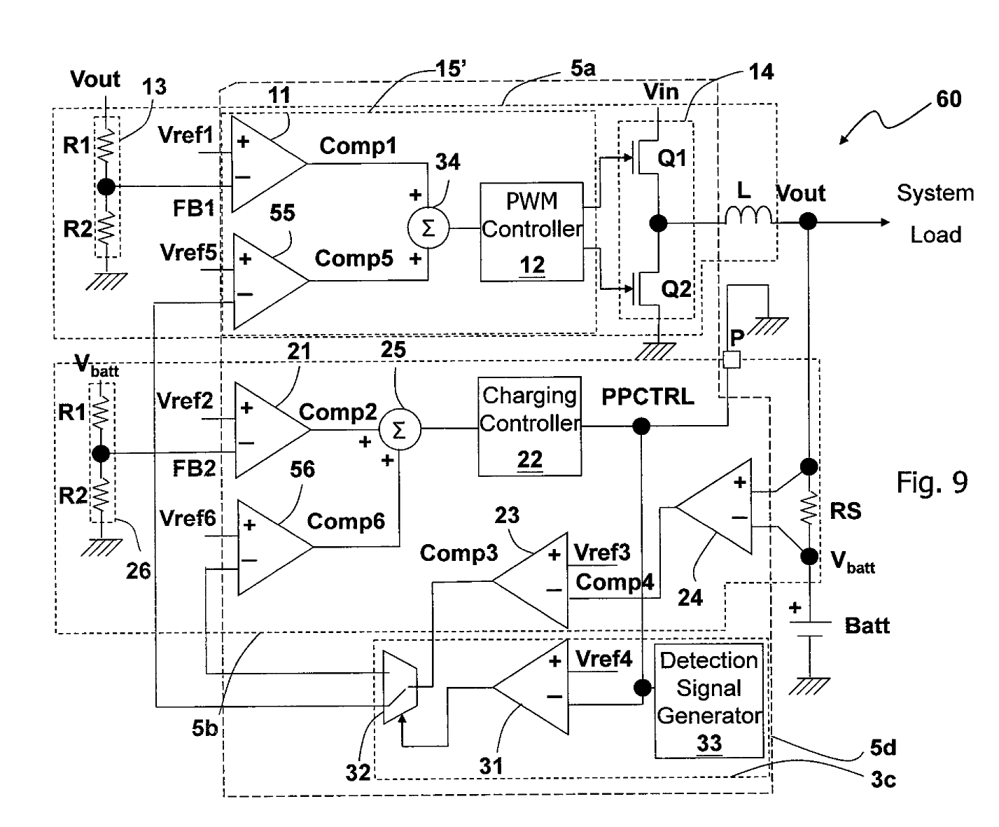

Referring FIGS. 8 and 9, these figure show another embodiment of the present invention which is also suitable for the applications of various connections between the system load and the battery. Compared with FIGS. 3 and 4, this embodiment further comprises error amplifiers 55 and 56 to respectively control a switching regulator 5a and a charging management circuit 5b for better accuracy. The parts similar to the embodiment in FIGS. 3 and 4 are not further explained below.

Referring to FIG. 8, the power supply system 50 comprises a switching regulator 5a, a charging management circuit 5b, a battery Batt, a PMOS transistor 27, and a path selection circuit 3c. The multiplexer 32 of the path selection circuit 3c designates the error signal Comp3 to be transmitted to the error amplifier 55 or 56. The error amplifier 55 compares the error signal Comp3 with a reference voltage Vref5 to output an error signal Comp5. The adder 34 sums up the error signals Comp1 and comp5, and output the sum to the PWM controller 12. Similarly, the error amplifier 56 compares the error signal Comp3 with a reference voltage Vref6 to output an error signal Comp6. The adder 25 sums up the error signals Comp2 and comp6, and output the sum to the charging controller 22. The difference between FIG. 8 and FIG. 3 is that the signal Comp3 representing the information of the charging current of the battery Batt is not inputted to the adder 25 or 34 in the same form of the same value. The signal Comp3 is compared with the reference voltage Vref5 or the reference voltage Vref6 to generate the error signal Comp5 or the error signal Comp6, and the error signal Comp5 or the error signal Comp6 is inputted to the adder 34 or the adder 25 correspondingly. In this way, the switch circuit 14 and the PMOS transistor 27 can be respectively controlled for better accuracy.

Compared with FIG. 8, the system load of the power supply system 60 in FIG. 9 is connected to the battery Batt through the sensing resistor RS without the PMOS transistor in between, and hence, the pin P for outputting the signal PPCRRL of the charging controller 22 is coupled to the ground. The detection signal outputted by the detection signal generator 33 results in a different voltage at the output node PPCTRL of the charging controller 22 in response to the non-existence of the PMOS transistor 27. After the comparator 31 checks the voltage, the multiplexer 32 can select a proper path. The error amplifiers (11, 55), the adder 34, and the PWM signal controller 12 form a switch control circuit 15′.

In one embodiment, the switch control circuit 15′, the switch circuit 14, the error amplifiers (11, 21, 23, 24, 55, 56), the charging controller 22, the adders (25, 34), and the path selection circuit 3c can be integrated into a chip or a multi-purpose power management apparatus 5d. Moreover, the chip or the apparatus is suitable for the application wherein the battery Batt is connected to the output side Vout through the PMOS transistor 27 and the sensing resistor RS, as shown in FIG. 8, and is also suitable for the application wherein the battery Batt is connected to the output side Vout through the sensing resistor RS only, as shown in FIG. 9.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the present invention is also applicable to the configuration wherein there is no resistor RS between the output side Vout and the battery Batt for sensing the charging current of the battery Batt (that is, the output side Vout is directly connected to the battery Batt). The multipurpose power management apparatus 3d or 5d of the present invention can be applied to such configuration if the input of the error amplifier 24 is grounded or floating. Thus, the present invention should cover all such and other modifications and variations, which should be interpreted to fall within the scope of the following claims and their equivalents.

What is claimed is:

1. A multi-purpose management apparatus controlling power conversion from input power to output power and controlling charging operation to a battery from the output power, the multi-purpose management apparatus comprising:
a switch circuit including at least one first power transistor;
a switch control circuit generating a switch signal operating the power transistor to control the power conversion from the input power to the output power;
a charging management circuit for controlling the charging operation from the output power to the battery; and
a path selection circuit determining whether the charging operation to the battery is controlled by the charging management circuit.

2. The multi-purpose management apparatus of claim 1, wherein when the output power is coupled to the battery through a second power transistor, the path selection circuit designates the charging management circuit to operate the second power transistor for controlling the charging operation to the battery; when the output power is not coupled to the battery through the second power transistor, the path selection circuit does not designate the charging management circuit to control the charging operation to the battery.

3. The multi-purpose management apparatus of claim 2, wherein when the output power is not coupled to the battery through the second power transistor, the path selection circuit selects the switch control circuit to receive information related to a battery charging current.

4. The multi-purpose management apparatus of claim 1, wherein the path selection circuit includes a multiplexer which determines whether the charging operation is controlled by the charging management circuit according to an external setting signal.

5. The multi-purpose management apparatus of claim 1, wherein the charging management circuit generates an output signal outputted through a pin, and the path selection circuit includes:
a detection signal generator generating a detection signal outputted through the pin to generate a detection voltage;
a comparator comparing the detection voltage with a reference voltage; and
a multiplexer determining whether the charging operation to the battery is controlled by the charging management circuit according to an output from the comparator.

6. The multi-purpose management apparatus of claim 2, wherein the charging management circuit includes a first error amplifier generating a first error signal according to information related to a battery charging current, and the path selection circuit determines to transmit the first error signal to the switch control circuit or the charging management circuit.

7. The multi-purpose management apparatus of claim 6, wherein the switch control circuit includes:
a second error amplifier generating a second error signal by comparing a feedback signal related to the output power with a second reference voltage;
an adder adding the second error signal to the first error signal when the path selection circuit determines to transmit the first error signal to the switch control circuit, but not adding the second error signal to the first error signal when the path selection circuit does not determine to transmit the first error signal to the switch control circuit; and
a pulse width modulation controller generating the switch signal to operate the first power transistor according to an output of the adder.

8. The multi-purpose management apparatus of claim 6, wherein the switch control circuit includes:
a second error amplifier generating a second error signal by comparing a feedback signal related to the output power with a second reference voltage;
a third error amplifier generating a third error signal by comparing the first error signal with a third reference voltage when the path selection circuit determines to transmit the first error signal to the switch control circuit;
an adder adding the second error signal and the third error signal; and
a pulse width modulation controller generating the switch signal to operate the first power transistor according to an output of the adder.

9. The multi-purpose management apparatus of claim 6, wherein the charging management circuit includes:
a second error amplifier generating a second error signal by comparing a feedback signal related to a voltage of the battery with a second reference voltage;
an adder adding the second error signal to the first error signal when the path selection circuit determines to transmit the first error signal to the charging management circuit, but not adding the second error signal to the first error signal when the path selection circuit does not determine to transmit the first error signal to the switch control circuit; and
a charging controller generating a signal to operate the second power transistor according to an output of the adder.

10. The multi-purpose management apparatus of claim 6, wherein the charging management circuit includes:
a second error amplifier generating a second error signal by comparing a feedback signal related to a voltage of the battery with a second reference voltage;
a third error amplifier generating a third error signal by comparing the first error signal with a third reference voltage when the path selection circuit determines to transmit the first error signal to the charging management circuit;
an adder adding the second error signal and the third error signal; and
a charging controller generating a signal to operate the second power transistor according to an output of the adder.

11. A charging path control circuit for selecting at least one control loop according to a connection relationship between an output power and a battery, the charging path control comprising:
a charging management circuit for controlling a charging operation to the battery from the output power; and
a path selection circuit determining whether the charging operation to the battery is controlled by the charging management circuit according to whether or not a power transistor is coupled between the output power and the battery.

12. The power path control circuit of claim 11, wherein the output power is converted from an input power by a switching regulator; when the power transistor is coupled between the output power and the battery, the path selection circuit feeds back information related to a battery charging current to the charging management circuit; when the power transistor is not coupled between the output power and the battery, the path selection circuit feeds back the information related to the battery charging current to the switching regulator.

13. The power path control circuit of claim 11, wherein the charging management circuit generates an output signal outputted through a pin, and the path selection circuit includes:
a detection signal generator generating a detection signal outputted through the pin to generate a detection voltage;
a comparator comparing the detection voltage with a reference voltage; and
a multiplexer determining whether the charging operation to the battery is controlled by the charging management circuit according to an output from the comparator.

14. A power path control method, comprising:
converting an input power to an output power;
performing a charging operation to a battery from the output power through a charging path;
detecting whether a power transistor is disposed on the charging path;
controlling the charging operation to the battery by controlling the power transistor when the power transistor is disposed on the charging path; and
controlling the charging operation to the battery by controlling the conversion between the input power and the output power when the power transistor is not disposed on the charging path.

15. The power path control method of claim 14, further comprising:
detecting a current on the charging path to generate information related to a battery charging current;
feeding back the information to control the power transistor when the power transistor is disposed on the charging path; and
feeding back the information to control the conversion between the input power and the output power when the power transistor is not disposed on the charging path.

16. The power path control method of claim 14, wherein the step of detecting whether the power transistor is disposed on the charging path comprises:
providing a pin for connecting to a gate terminal of the power transistor or to ground;
generating a detection signal outputted through the pin to generate a detection voltage; and
comparing the detection voltage with a reference to determine whether the power transistor exists.
